(19) United States
(12) Patent Application Publication
(10) Pub. No.: US 2010/0195468 A1
(43) Pub. Date: Aug. 5, 2010

(54) OPTICAL DATA STORAGE MEDIA CONTAINING METAL AND METAL OXIDE DARK LAYER STRUCTURE

(75) Inventors: Matthew R. Linford, Orem, UT (US); Barry M. Lunt, Provo, UT (US)

Correspondence Address: Pepper/Millenniata, 50th Floor, 500 Grant Street, Pttsburgh, PA, 15219-2502, US

(73) Assignee: BRIGHAM YOUNG UNIVERSITY, Provo, UT (US)

(21) Appl. No.: 12/696,534

(22) Filed: Jan. 29, 2010

Related U.S. Application Data
(60) Provisional application No. 61/206,372, filed on Jan. 30, 2009.

(51) Int. Cl. G11B 7/00; B32B 3/02; G11B 7/24; B05D 5/06; G11B 7/252

(52) U.S. Cl. 369/100; 428/64.4; 427/162; G9B/7

(57) ABSTRACT

Optical data storage media containing a “dark” layer structure are disclosed. Layered metals and metal oxides provide a dark background that enhances detection of changes in the data layer of the storage media. Combinations such as chromium metal and chromium oxide, and molybdenum metal and molybdenum oxide are offered as examples of suitable materials.

This application claims the benefit of U.S. Provisional Application No. 61/206,372 entitled “OPTICAL DATA STORAGE MEDIA CONTAINING METAL AND METAL OXIDE DARK LAYER STRUCTURE” filed on Jan. 30, 2009, the contents of which are incorporated herein by reference.

### TECHNICAL FIELD

The invention relates to optical data storage media containing a dark layered structure. In particular, media containing a metal and metal oxide dark layered structure are disclosed.

### BACKGROUND

In very general terms, optical data storage media function by creation and detection of marks in a disc, tape, or other physical media. Areas containing a mark are distinguishable from areas lacking a mark due to some detectable difference in optical performance. Detectable differences can include differences in reflectivity, absorption, emission, and so on. The change can be an increase or decrease in any of the detectable properties, depending on the particular design of the media. Many commercial products use laser irradiation of organic dyes or metals in a data layer to effect the detectable change.

Reflective layers have been widely used adjacent to the data layer to enhance detection of the change. A “read” laser applies energy to the data layer, and energy is reflected back towards a detector by the reflective layer. Reflective layers are typically made of inexpensive aluminum.

A material widely used in other uses is a combination of chromium metal and chromium oxide. This material is used in catalysis, solar power collectors, and as black matrix films in liquid crystal displays. Thermal solar collectors are commercially available from a variety of suppliers, such as the “Krosol” product from Materials Technology Inc. (Somerset, N.J.). Liquid crystal displays are available from companies such as Samsung America (Ridgefield Park, N.J.) and Panasonic Corporation of America (Secaucus, N.J.). The material is attractive due to its very dark, highly light absorbing appearance. Despite its wide industrial adoption, chromium based “dark layers” have not been widely used in optical data storage media.

U.S. Pat. No. 6,039,898 (issued Mar. 21, 2000) proposes optical memory devices having a pattern of spaced-apart regions that contain fluorescent material in the regions, but not in the spaces between the regions. The patent suggests that in order to eliminate or substantially reduce the reflection of the device, a metal layer can be oxidized. Reflective metals such as aluminum or chromium can be applied onto the patterned surface prior to addition of the fluorescent material. The oxidized layer is located between the substrate layer and the fluorescent material.

Despite the widespread industrial application of chromium and chromium oxide “dark” materials, these have not been fully taken advantage of in optical data storage media.

### SUMMARY

Optical storage media containing a metal layer facially contacting a metal oxide layer are disclosed. The combined layers produce a “dark” background structure that is useful for improving the contrast and detectability of written versus unwritten portions of the media's data layer.

### DESCRIPTION OF THE FIGURES

The following figures form part of the present specification and are included to further demonstrate certain aspects of the present invention. The invention may be better understood by reference to one or more of these figures in combination with the detailed description of specific embodiments presented herein.

FIG. 1 shows an optical data storage medium having a support substrate, a data layer, a metal oxide layer, and a metal layer.

FIG. 2 shows an optical data storage medium having a support substrate, one or more intervening layers, a data layer, a metal oxide layer, and a metal layer.

FIG. 3 shows an optical data storage medium having a support substrate, a data layer, one or more intervening layers, a metal oxide layer, and a metal layer.

FIG. 4 shows an optical data storage medium having a support substrate, one or more first intervening layers, a data layer, one or more second intervening layers, a metal oxide layer, and a metal layer.

FIG. 5 shows an optical data storage medium having a support substrate, a data layer, a metal oxide layer, a metal layer, and one or more additional layers.

FIG. 6 shows an optical data storage medium having a first support substrate, a data layer, a metal oxide layer, a metal layer, and a second support substrate.

### DETAILED DESCRIPTION

While compositions and methods are described in terms of “comprising” various components or steps (interpreted as meaning “including, but not limited to”), the compositions and methods can also “consist essentially of” or “consist of” the various components and steps, such terminology should be interpreted as defining essentially closed-member groups.

Materials

Various embodiments of the invention take advantage of the combination of a metal layer and an adjacent metal oxide layer. This combined structure can cause destructive interference as light enters the metal oxide layer and is reflected by the metal layer surface. This effectively causes absorption of the light, not reflectance.

One embodiment of the present invention is directed towards an optical data storage medium comprising: at least one metal layer, at least one metal oxide layer, at least one data layer, and at least one support substrate. The metal oxide layer facially contacts the metal layer. The distance from the support substrate to the metal oxide layer is less than the distance from the support substrate to the metal layer. In other words, a cross section would first intersect the support substrate, then the metal oxide layer, then the metal layer. The distance from the support substrate to the data layer is less than the distance from the support substrate to the metal oxide layer. In other words, a cross section would first intersect the support substrate, then the data layer, then the metal oxide layer, then the metal layer.

In another embodiment, the optical data storage medium comprises at least one metal oxide layer and at least one metal layer supported on at least one support substrate. In this embodiment, the distance from the support substrate to the metal oxide layer is less than the distance from the support substrate to the metal layer. In other words, a cross section would intersect the support substrate, the metal oxide layer, and the metal layer, in that order. In this case, the metal oxide layer may act substantially as the data layer. For example, when energy from a laser removes the metal oxide or otherwise causes changes that interrupt the destructive interference of the metal oxide layer at positions corresponding to data marks, then bright or more reflective spots are created at the marks while the metal oxide provides an absorptive layer everywhere else. Thus, the stack of layers is configured to create a contrast between the absorptive layer formed by the metal oxide at unwritten locations and the written locations where the metal oxide has been removed or modified in a way that causes greater reflectance at the written marks. The greater reflection may be due to the more reflective overlying metal layer or some modification in the metal oxide layer.

The metal layer can comprise, consist essentially of, or consist of at least one metal. The metal layer preferably is reflective with respect to incoming light. Examples of metals include chromium metal (Cr), molybdenum metal (Mo), tungsten metal (W), lead metal (Pb), tantalum metal (Ta), rhodium metal (Rh), cadmium metal (Cd), indium metal (In), zinc metal (Zn), iron metal (Fe), and magnesium metal (Mg). The metal layer can contain one metal, or mixtures of two or more metals.

The metal layer can generally be any thickness. Example thicknesses include about 10 nm, about 20 nm, about 30 nm, about 40 nm, about 50 nm, about 60 nm, about 70 nm, about 80 nm, about 90 nm, about 100 nm, about 200 nm, about 300 nm, about 400 nm, about 500 nm, about 600 nm, about 700 nm, about 800 nm, about 900 nm, about 1000 nm, and ranges between any two of these values.

The metal oxide layer can comprise, consist essentially of, or consist of at least one metal oxide. Examples of metal oxide include chromium oxide (CrOₓ), molybdenum oxide (MoOₓ), tungsten oxide (WOₓ, W₂O₃, WO₂, WO₃), lead oxide (PbOₓ, PbO, Pb₃O₄, PbO₂, Pb₂O₃, Pb₁₂O₁₉), tantalum oxide (TaOₓ, Ta₂O₅), rhodium oxide (RhOₓ, Rh₂O₃, RhO₂), cadmium oxide (CdOₓ, CdO), indium oxide (InOₓ, In₂O₃), iron oxide (FeOₓ, Fe₂O₃), and magnesium oxide (MgOₓ, MgO). Chromium oxide can exist in multiple forms, such as CrO, Cr₂O₃, CrO₂, Cr₅O₁₂, Cr₂O₅, and CrO₃. A presently preferred metal oxide is Cr₂O₃ due to its wide availability and low cost. Molybdenum oxide can exist in multiple forms such as MoO₂ and MoO₃. The metal oxide layer can contain one metal oxide, or mixtures of two or more metal oxides.

The metal oxide can contain the same metal as the metal layer, or it can contain a different metal. For example, the metal layer can be chromium, and the metal oxide can be chromium oxide (where both metals are the same metal). An example of an alternative configuration may include chromium in the metal layer, and molybdenum oxide as the metal oxide (such that the two metals are different). Embodiments where both metals are the same metal may facilitate manufacturing.

The metal oxide layer can generally be any thickness. Example thicknesses include about 10 nm, about 20 nm, about 30 nm, about 40 nm, about 50 nm, about 60 nm, about 70 nm, about 80 nm, about 90 nm, about 100 nm, about 200 nm, about 300 nm, about 400 nm, about 500 nm, about 600 nm, about 700 nm, about 800 nm, about 900 nm, about 1000 nm, and ranges between any two of these values.

The thickness of the metal oxide layer can be calculated to vary according to the wavelength of light used to read sites in the data layer. In order to optimize destructive interference of (a) light reflected off of the metal oxide layer, and (b) light that first passes through the metal oxide layer, reflected off of the metal layer, and then passes back through the metal oxide layer, the light from (a) and (b) will be out of phase. The thickness to accomplish this can be calculated using the formula: thickness=(λ/4n), where λ is the wavelength of the light, and “n” is the index of refraction of the metal oxide layer. The index of refraction for various materials can be obtained from a wide variety of books and other reference materials. The index of refraction varies somewhat for a given material at different wavelengths. For example, Cr₂O₃ has an n value of 2.21 at 650 nm, but an n value of 2.18 at 780 nm. Fe₂O₃ has an n value of 2.6 at 650 nm, but an n value of 2.47 at 780 nm.

The (lambda/4n) formula optimizes the destructive interference caused by the metal layer and metal oxide layer structure for light approaching the metal oxide layer at 90 degrees. In most optical media, light approaches at approximately 90 degrees, so this formula is a close approximation of the metal oxide layer thickness. As an example, if the wavelength is 650 nm, the metal oxide layer is made of Cr₂O₃, and n is 2.21, the thickness is calculated to be about 74 nm. For a second example, if the wavelength is 780 nm, the metal oxide layer is made of Fe₂O₃, and n is 2.47, the thickness is calculated to be about 79 nm.

The data layer can generally be any material or materials suitable for writing data to, and reading data from using a suitable device such as a disc drive. The carbon layer can generally be used with any data layer to form various embodiments of the instant invention. Examples of materials used in data layers include organic dyes, metals, metal alloys, metal oxides, glasses, or ceramics.

The data layer can generally be any thickness. A lower thickness limit can be about 2 nm. An upper thickness limit can be about 250 nm. Exemplary thicknesses may include about 2 nm, about 4 nm, about 6 nm, about 8 nm, about 10 nm, about 12 nm, about 14 nm, about 16 nm, about 18 nm, about 20 nm, about 30 nm, about 40 nm, about 50 nm, about 60 nm, about 70 nm, about 80 nm, about 90 nm, about 100 nm, about 110 nm, about 120 nm, about 130 nm, about 140 nm, about 150 nm, about 160 nm, about 170 nm, about 180 nm, about 190 nm, about 200 nm, about 210 nm, about 220 nm, about 230 nm, about 240 nm, about 250 nm, and ranges between any two of these values.

The data layer can further comprise sites to which data has been written. The sites exhibit a detectable difference from other sites to which data has not been written.

The support substrate can generally be any material compatible with use in optical information storage. Polymers or ceramic materials having desirable optical and mechanical properties are widely available. Support substrates typically comprise polycarbonate, polystyrene, aluminum oxide, polydimethyl siloxane, polymethylmethacrylate, silicon oxide, glass, aluminum, stainless steel, or mixtures thereof. If substrate transparency is not desired, then metal substrates may be used. Other optically transparent plastics or polymers may also be used. Support substrates can be selected from materials having sufficient rigidity or stiffness. Rigidity or stiffness is commonly measured as Young's modulus in units of pressure per unit area, and preferably is about 0.5 GPa to about 70 GPa. Specific examples of stiffness values are about 0.5 GPa, about 1 GPa, about 5 GPa, about 10 GPa, about 20 GPa, about 30 GPa, about 40 GPa, about 50 GPa, about 60 GPa, about 70 GPa, and ranges between any two of these values. Support substrates can be selected from materials having an index of refraction of about 1.45 to about 1.70. Specific examples of an index of refraction include about 1.45, about 1.5, about 1.55, about 1.6, about 1.65, about 1.7, and ranges between any two of these values.

The substrate preferably comprises materials that are not subject to age degradation effects. Presently preferred materials are polycarbonate, glass, and silicon oxide (fused silica).

The support substrate can generally be any thickness. The substrate thickness can be selected as a function of the drive capacity: 1.2 millimeter-thick substrates are compatible with CD drives, 0.6 millimeter-thick substrates are compatible with DVD drives, and 0.1 millimeter-thick substrates are compatible with BD drives.

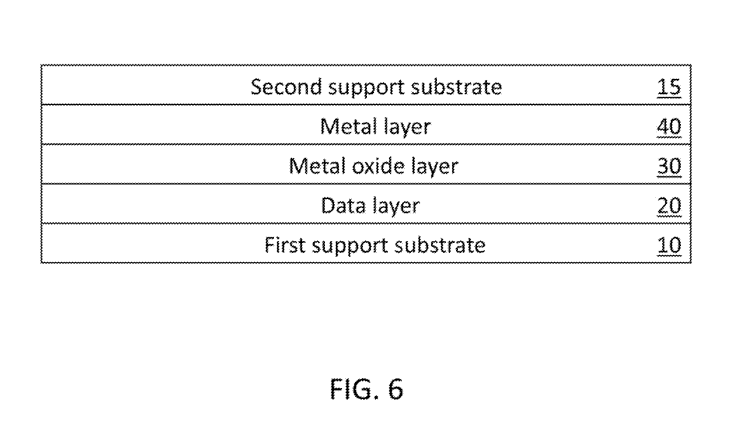

The optical data storage medium can comprise a first support substrate and a second support substrate. The first support substrate and second support substrate can be made of the same material, or can be made of different materials. The first support substrate and the second support substrate typically are oriented such that they form the outer two layers of the optical data storage medium (i.e. are the first and last layers when viewed as a cross section). This is especially true in a DVD-type format. An optical data storage medium having a first support substrate 10 and a second support substrate 15 is shown in FIG. 6.

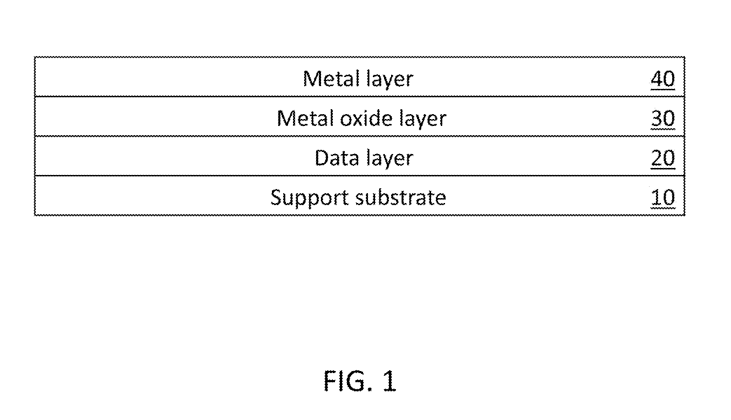

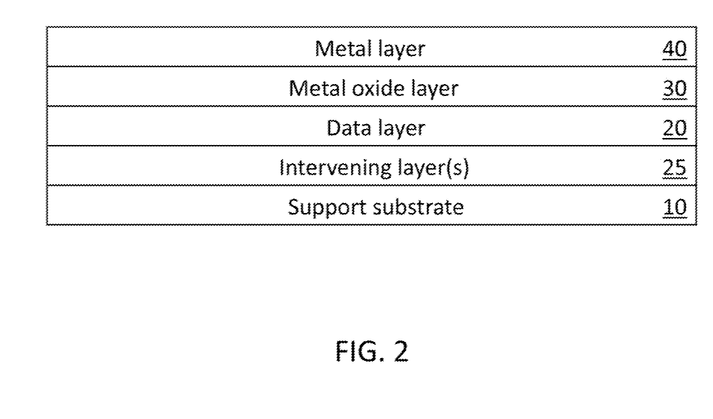

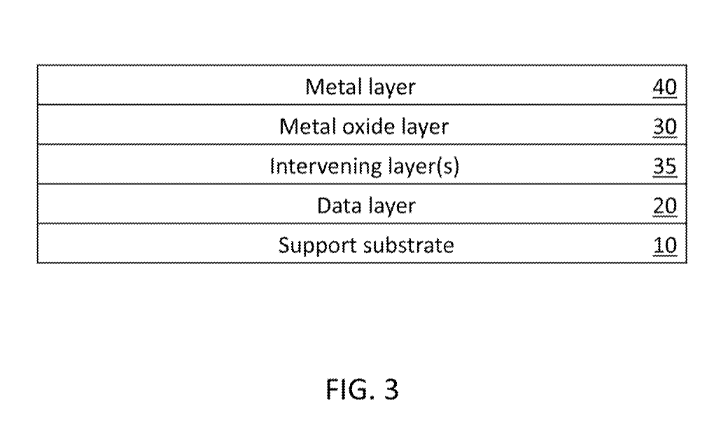

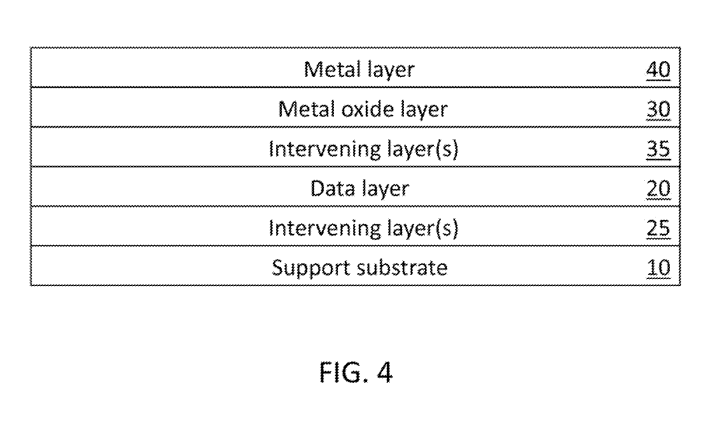

The support substrate 10 can facially contact the data layer 20, as shown in FIGS. 1, 3, 5, and 6. Alternatively, there can be at least one intervening layer 25 between the support substrate 10 and the data layer 20, as shown in FIGS. 2 and 4. The data layer 20 can facially contact the metal oxide layer 30, as shown in FIGS. 1, 2, 5, and 6. Alternatively, there can be at least one intervening layer 35 between the data layer 20 and the metal oxide layer 30, as shown in FIGS. 3 and 4. These arrangements of layers are graphically shown in FIGS. 1-6, and may be combined in any manner without limitation.

An example of an intervening layer is a thermal barrier layer. A thermal barrier layer can protect the substrate from heat generated during writing data to the data layer. Examples of thermal barrier layers include silica (SiO₂), carbon, alumina, silicon, silicon nitride, boron nitride, titanium oxides (TiOₓ), and tantalum oxides (TaOₓ).

An additional example of an intervening layer is a heat conduction layer. This type of layer conducts heat away from the sites to which data has been written, reducing or eliminating thermal damage to adjacent sites.

It is to be understood that these and other types of intervening layers may be placed between any two of the layers without limitation.

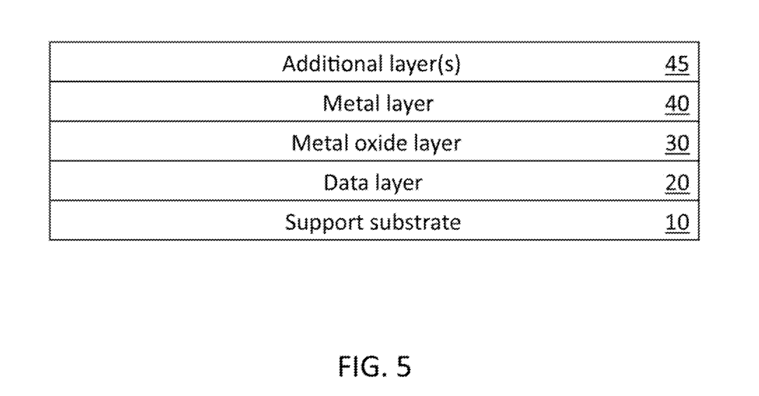

While FIGS. 1-4 show the metal layer 40 as the topmost layer, one or more additional layers 45 can be placed on top of the metal layer 40. This option is shown in FIG. 5. An example of an additional layer is a polymer protective layer.

A cross-section view of the optical data storage medium can be symmetrical or asymmetrical. The cross-section is most commonly asymmetrical.

In a particular embodiment of the invention, the optical data storage medium can comprise a metal layer 40, a metal oxide layer 30, a data layer 20, and a support substrate 10; wherein: the metal layer 40 consists of chromium metal (Cr); the metal oxide layer 30 consists of chromium oxide (CrOₓ); the data layer 20 facially contacts the metal oxide layer 30; the metal oxide layer 30 facially contacts the metal layer 40; the distance from the support substrate 10 to the metal oxide layer 30 is less than the distance from the support substrate 10 to the metal layer 40; and the distance from the support substrate 10 to the data layer 20 is less than the distance from the support substrate 10 to the metal oxide layer 30. A cross section of the medium would first intersect the support substrate 10, then the data layer 20, then the metal oxide layer 30, then the metal layer 40.

In another particular embodiment, the optical data storage medium may not have a distinct data layer 20. Rather, the metal oxide layer material and/or other material may provide the data layer/data material. In this case, a cross section of the medium would first intersect the support substrate 10, then the metal oxide layer 30, then the metal layer 40 in this order.

Methods of Preparation

Additional embodiments of the invention are directed towards methods of preparing an optical data storage medium.

The various layers can be applied in various orders, depending on the particular layering desired in the optical information medium product. The layers can all be applied on one side of the support substrate, resulting in a final product having the support substrate on one outer face. Alternatively, the layers can be applied onto both sides of the support substrate, resulting in a final product having the support substrate located such that it is not an outer face of the final product.

In one embodiment, the method can comprise providing at least one support substrate, applying at least one data layer, applying at least one metal oxide layer, and applying at least one metal layer such that the metal oxide layer facially contacts the metal layer. The support substrate can facially contact the data layer. The data layer can facially contact the metal oxide layer. This method produces an optical data storage medium such as the one shown in FIG. 1.

In an alternative embodiment, the method can comprise providing at least one support substrate, applying at least one intervening layer, applying at least one data layer, applying at least one metal oxide layer, and applying at least one metal layer such that the metal oxide layer facially contacts the metal layer. The support substrate can facially contact the intervening layer. The intervening layer can facially contact the data layer. The data layer can facially contact the metal oxide layer. This method produces an optical data storage medium such as the one shown in FIG. 2.

In an alternative embodiment, the method can comprise providing at least one support substrate, applying at least one data layer, applying at least one intervening layer, applying at least one metal oxide layer, and applying at least one metal layer such that the metal oxide layer facially contacts the absorptive metal layer. The support substrate can facially contact the data layer. The data layer can facially contact the intervening layer. The intervening layer can facially contact the metal oxide layer. This method produces an optical data storage medium such as the one shown in FIG. 3.

In an alternative embodiment, the method can comprise providing at least one support substrate, applying at least one first intervening layer, applying at least one data layer, applying at least one second intervening layer, applying at least one metal oxide layer, and applying at least one metal layer such that the metal oxide layer facially contacts the metal layer. The support substrate can facially contact the first intervening layer. The first intervening layer can facially contact the data layer. The data layer can facially contact the second intervening layer. The second intervening layer can facially contact the metal oxide layer. This method produces an optical data storage medium such as the one shown in FIG. 4.

Any of the above described methods may be modified to exclude the addition of a distinct data layer. In this case, the metal oxide may be applied to provide contrast and to act at least in part as a data layer. Thus, by removing or disturbing the metal oxide layer at the data points may cause a change in reflectance in comparison at other unmarked portions of the metal oxide layer.

Any of the above described methods can further comprise applying at least one additional layer after the applying a metal layer step. Adding this additional step produces an optical data storage medium such as the one shown in FIG. 5.

Methods of Use

Any of the above described optical data storage mediums can be used to store digital data. Methods can comprise providing a optical information medium comprising: at least one metal layer, at least one metal oxide layer, at least one data layer, and at least one support substrate, and applying energy to sites in the data layer to cause a detectable change in the data layer. The method can further comprise detecting the change in the data layer.

Detecting the change in the data layer may include detecting a change in contrast in which marked regions have openings in the data layer or thinned portions in the data layer that expose the metal oxide that provides destructive interference. Thus, using the optical data storage medium may include detecting a higher reflectance in unwritten regions than in written regions. Since the metal oxide destructively interferes and absorbs reading radiation at the marks to a greater degree than it does in regions that remain covered by undisturbed data layer material, the contrast is between more reflective unwritten portions and less reflective written portions. Alternatively, a dark or absorptive data layer could be provided and the metal oxide could be replaced by a material that constructively interferes to provide greater reflectance at the written portions than at the unwritten portions of the medium.

In one embodiment, a distinct data layer has been omitted. Thus, the method of using the optical storage medium may include modifying the metal oxide layer at data points such that there is a distinct reflectance at the written data points in comparison with regions of the metal oxide layer that remain unwritten. The method also includes detecting a change in reflectance in which the reflectance is increased at the marks in which the metal oxide layer has been disturbed by laser energy during writing. Alternatively, the metal oxide may be replaced by a material that constructively interferes with the laser radiation. Thus, the reflectance may be greater in unmarked regions than in marked regions where the laser radiation has affected the material that constructively interferes. The method may thus include detecting the contrast between more reflective unwritten regions and less reflective written regions.

Applying energy to sites in the data layer can also locally generate sufficient heat to deform tracks in the support substrate, especially when the optical data storage medium does not contain a thermal barrier layer and/or heat conduction layer. Deformed sites in the support substrate can be subsequently detected.

Lasers can be used in the applying energy step and in the detecting step. Main classes of lasers include gas, diode-pumped solid state, and diode lasers.

The following examples are included to demonstrate preferred embodiments of the invention. It should be appreciated by those of skill in the art that the techniques disclosed in the examples which follow represent techniques discovered by the inventor(s) to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the scope of the invention.

### EXAMPLES

### Example 1

### Materials

Polycarbonate blank discs are commercially available from a variety of sources such as Bayer MaterialScience AG (Leverkusen, Germany), General Electric Company (Fairfield, Conn.), and Teijin Limited (Osaka, Japan). Fused silica blank discs are commercially available from a variety of sources such as Corning Incorporated (Corning, N.Y.), Hoya Corporation (Tokyo, Japan), and Schott AG (Mainz, Germany).

### Prophetic Example 2

### Preparation of Polycarbonate Optical Disc

A polycarbonate disc can be coated with a silica dielectric layer. An organic dye layer such as a phthalocyanine dye or azo-cyanine dye can be applied. A chromium oxide layer, followed by a chromium metal layer can be applied. A protective lacquer coating can be finally applied to protect the top surface of the disc.

### Prophetic Example 3

### Preparation of Silica Optical Disc

A silica disc can be coated with a ZnS—SiO₂ dielectric layer. A metal data layer such as tellurium can be applied. A molybdenum oxide layer, followed by a molybdenum metal layer can be applied. A protective polymer coating can be finally applied to protect the top surface of the disc.

### Example 4

### Mathematical Calculation for Preparation of an Optical Disc Having an Al Data Layer Backed by CrO₂/Cr with Optimal Layer Thicknesses

The reflectivity of a representative system was modeled using TFCalc v. 1.5.19 modeling software (Software Spectra, Portland, Oreg.). The model was constructed using a white light source and an ideal detector, both of which are included in the software. The incident media was chosen to be air while the exit media was polycarbonate. The model used a polycarbonate support substrate. The films making up the representative system were inserted between the polycarbonate substrate and the polycarbonate exit media. A wavelength of 650 nm corresponding to the wavelength of a typical DVD read laser was chosen as the reference wavelength for the model. The chromium metal layer thickness was arbitrarily selected to provide less than 5% transmittance of the radiation at 650 nm. In order to determine an oxide layer thickness that would function well, the thickness was optimized to provide less than 5% reflection. Then, the thickness of the aluminum write layer was optimized to give 70% reflection. The representative system was thus modeled with a 60 nm thick layer of silicon dioxide applied to the support substrate, an 11 nm thick layer of aluminum data layer applied atop the silicon dioxide, a 55 nm thick layer of CrO₂ applied atop the aluminum data layer, and a 500 nm thick layer of chromium metal applied atop the CrO₂. This modeling resulted in the thicknesses for the aluminum data layer and the CrO₂ layer listed above. Running the software showed a reflectivity of about 70% before writing and a reflectivity of about 20% after writing. Thus, a disc built with a stack of these materials having these thicknesses is expected to provide excellent contrast between written and unwritten portions of the disc. In particular, it is expected that the written portions of the disc will be darker (less reflective) than the unwritten portions, which are expected to remain lighter (more reflective).

### Example 5

### Mathematical Calculation for Preparation of an Optical Disc Having an Al Data Layer Backed by MoO₃/Mo with Optimal Layer Thicknesses

The reflectivity of a representative system was modeled using TFCalc v. 1.5.19 modeling software (Software Spectra, Portland, Oreg.). The model was constructed using a white light source and an ideal detector, both of which are included in the software. The incident media was chosen to be air while the exit media was polycarbonate. The model used a polycarbonate support substrate. The films making up the representative system were inserted between the polycarbonate substrate and the polycarbonate exit media. A wavelength of 650 nm corresponding to the wavelength of a typical DVD read laser was chosen as the reference wavelength for the model. The molybdenum metal layer thickness was arbitrarily selected to provide less than 5% transmittance of the radiation at 650 nm. In order to determine an oxide layer thickness that would function well, the thickness was optimized to provide less than 5% reflection. Then, the thickness of the aluminum write layer was optimized to give 70% reflection. The representative system was thus modeled with a 60 nm thick layer of silicon dioxide applied to the support substrate, a 13.23 nm thick layer of aluminum data layer applied atop the silicon dioxide, a 79.03 nm thick layer of MoO₃ applied atop the aluminum data layer, and a 500 nm thick layer of molybdenum metal applied atop the MoO₃. This modeling resulted in the thicknesses for the aluminum data layer and the MoO₃ layer listed above. Running the software showed a reflectivity of about 70% before writing and a reflectivity of about 10.6% after writing. Thus, a disc built with a stack of these materials having these thicknesses is expected to provide excellent contrast between written and unwritten portions of the disc. In particular, it is expected that the written portions of the disc will be darker (less reflective) than the unwritten portions, which are expected to remain lighter (more reflective).

### Example 6

### Mathematical Calculation for Preparation of an Optical Disc Having an Al Data Layer Backed by MoO₃/Cr with Optimal Layer Thicknesses

The reflectivity of a representative system was modeled using TFCalc v. 1.5.19 modeling software (Software Spectra, Portland Oreg.). The model was constructed using a white light source and an ideal detector, both of which are included in the software. The incident media was chosen to be air while the exit media was polycarbonate. The model used a polycarbonate support substrate. The films making up the representative system were inserted between the polycarbonate substrate and the polycarbonate exit media. A wavelength of 650 nm corresponding to the wavelength of a typical DVD read laser was chosen as the reference wavelength for the model. The molybdenum metal layer thickness was arbitrarily selected to provide less than 5% transmittance of the radiation at 650 nm. In order to determine an oxide layer thickness that would function well, the thickness was optimized to provide less than 5% reflection. Then, the thickness of the aluminum write layer was optimized to give 70% reflection. The representative system was thus modeled with a 60 nm thick layer of silicon dioxide applied to the support substrate, a 12.85 nm thick layer of aluminum data layer applied atop the silicon dioxide, a 72.42 nm thick layer of MoO₃ applied atop the aluminum data layer, and a 500 nm thick layer of chromium metal applied atop the MoO₃. This modeling resulted in the thicknesses for the aluminum data layer and the MoO₃ layer listed above. Running the software showed a reflectivity of about 70% before writing and a reflectivity of about 10% after writing. Thus, a disc built with a stack of these materials having these thicknesses is expected to provide excellent contrast between written and unwritten portions of the disc. In particular, it is expected that the written portions of the disc will be darker (less reflective) than the unwritten portions, which are expected to remain lighter (more reflective).

### Example 7

### Preparation of Polycarbonate Optical Disc with Aluminum Data Layer and Chromium Oxide/Chromium Metal Layer Stack

A polycarbonate support substrate was provided. A dielectric layer of SiO₂ was sputtered to a thickness of approximately 60 nm using a Sprinter model 9 sputter deposition tool by Oerlikon Corporation, Pfaffikon, Switzerland. An aluminum data layer was sputtered to a thickness of approximately 26 nm atop the SiO₂ dielectric layer. A chromium oxide destructive interference layer was sputtered to a thickness of approximately 81 nm atop the aluminum data layer. A chromium metal layer was sputtered to a thickness of approximately 110 nm atop the chromium oxide layer. The aluminum, chromium oxide, and chromium layers were sputtered using a PVD 75 sputter deposition instrument (Kurt J. Lesker Company; Pittsburgh, Pa.).

### Example 8

### Writing to and Reading from the Polycarbonate Optical Disc of Example 7 Having the Aluminum Data Layer and Chromium Oxide/Chromium Metal Layer Stack

Reflectivity was measured using an ODU1000 analytical instrument (Pulstec Industrial Co., Ltd.; Hamamatsu-City; Japan) with a diode laser set at a wavelength of 650 nm. The disc had an unwritten reflectivity, as seen by the ODU, of about 765 mV. Modulation was achieved by writing with the ODU at 4× at determined high powers optimally above 100 mV. Modulation was also easily achieved by writing with the ODU at 1× at powers optimally of approximately 50 mW to approximately 60 mW. The written areas on the disc became darker in comparison to the unwritten areas. Marks having sizes from 14T down to 3T were written to the disc using a ROM-1 pattern and a 1× multi-pulse write strategy. Modulation of 78% was achieved. These results indicate that this system of layers is a functional system for writing and reading optical digital data.

### Example 9

### Preparation of Polycarbonate Optical Disc with a Carbon Coated Aluminum Data Layer and Chromium Oxide/Chromium Metal Layer Stack

A polycarbonate support substrate was provided. A dielectric layer of SiO₂ was sputtered to a thickness of approximately 60 nm using a Sprinter model 9 sputter deposition tool by Oerlikon Corporation, Pfaffikon, Switzerland. A carbon protective/absorptive layer was sputtered to a thickness of approximately 15 nm atop the SiO₂. An aluminum data layer was sputtered to a thickness of approximately 26 nm atop the carbon protective/absorptive layer. A chromium oxide destructive interference layer was sputtered to a thickness of approximately 81 nm atop the aluminum data layer. A chromium metal layer was sputtered to a thickness of approximately 110 nm atop the chromium oxide layer. The aluminum, chromium oxide, and chromium layers were sputtered using a PVD 75 sputter deposition instrument (Kurt J. Lesker Company; Pittsburgh, Pa.) to deposit these layers on the support substrate in this order.

### Example 10

### Writing to and Reading from the Polycarbonate Optical Disc of Example 9 Having the Carbon Coated Aluminum Data Layer and Chromium Oxide/Chromium Metal Layer Stack

Reflectivity was measured using an ODU1000 analytical instrument (Pulstec Industrial Co., Ltd.; Hamamatsu-City; Japan) with a diode laser set at a wavelength of 650 nm. The disc had an unwritten reflectivity, as seen by the ODU, of about 250 mV. Modulation was achieved by writing with the ODU at 4× at a near-optimum write power of about 65 mW to about 85 mW. The written areas on the disc became darker in comparison to the unwritten areas. The optimal power was selected by writing 14T marks. A multi-pulse ROM-1 pattern of marks from 14T to 3T were written to the disc at powers in the optimal range. Without strategy optimization, the existence of populations of marks of different size in the ROM-1 pattern was detectable in a data-data histogram, although the populations were not clearly distinct. The modulation of approximately 73% was achieved. These results indicate that this system of layers is a functional system for writing and reading optical digital data.

All of the compositions and/or methods and/or processes and/or apparatuses disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and/or apparatus and/or processes and in the steps or in the sequence of steps of the methods described herein without departing from the concept and scope of the invention. More specifically, it will be apparent that certain agents which are both chemically and physically related may be substituted for the agents described herein while the same or similar results would be achieved. All such similar substitutes and modifications apparent to those skilled in the art are deemed to be within the scope and concept of the invention.

What is claimed is:

1. An optical data storage medium comprising: at least one metal layer, at least one metal oxide layer, at least one data layer, and at least one support substrate;
wherein:
the metal oxide layer facially contacts the metal layer;
the distance from the support substrate to the metal oxide layer is less than the distance from the support substrate to the metal layer; and
the distance from the support substrate to the data layer is less than the distance from the support substrate to the metal oxide layer.

2. The optical data storage medium of claim 1, wherein the metal layer comprises chromium metal (Cr), molybdenum metal (Mo), tungsten metal (W), lead metal (Pb), tantalum metal (Ta), rhodium metal (Rh), cadmium metal (Cd), indium metal (In), zinc metal (Zn), iron metal (Fe), or magnesium metal (Mg).

3. The optical data storage medium of claim 1, wherein the metal layer comprises chromium metal (Cr).

4. The optical data storage medium of claim 1, wherein the metal layer comprises molybdenum metal (Mo).

5. The optical data storage medium of claim 1, wherein the metal layer consists of chromium metal (Cr).

6. The optical data storage medium of claim 1, wherein the metal layer consists of molybdenum metal (Mo).

7. The optical data storage medium of claim 1, wherein the metal layer has a thickness of about 10 nm to about 1000 nm.

8. The optical data storage medium of claim 1, wherein the metal oxide layer comprises chromium oxide, molybdenum oxide, tungsten oxide, lead oxide, tantalum oxide, rhodium oxide, cadmium oxide, indium oxide, iron oxide, or magnesium oxide.

9. The optical data storage medium of claim 1, wherein the metal oxide layer comprises chromium oxide.

10. The optical data storage medium of claim 1, wherein the metal oxide layer comprises CrO, Cr₂O₃, CrO₂, Cr₅O₁₂, Cr₂O₅, CrO₃, or mixtures thereof.

11. The optical data storage medium of claim 1, wherein the metal oxide layer comprises molybdenum oxide.

12. The optical data storage medium of claim 1, wherein the metal oxide layer comprises MoO₂, MoO₃, or mixtures thereof.

13. The optical data storage medium of claim 1, wherein the metal oxide layer consists of chromium oxide.

14. The optical data storage medium of claim 1, wherein the metal oxide layer consists of CrO, Cr₂O₃, CrO₂, Cr₅O₁₂, Cr₂O₅, CrO₃, or mixtures thereof.

15. The optical data storage medium of claim 1, wherein the metal oxide layer consists of molybdenum oxide.

16. The optical data storage medium of claim 1, wherein the metal oxide layer consists of MoO₂, MoO₃, or mixtures thereof.

17. The optical data storage medium of claim 1, wherein the metal oxide layer has a thickness of about 10 nm to about 1000 nm.

18. The optical data storage medium of claim 1, wherein the metal oxide layer has a thickness of about (lambda/4n), where “lambda” is the wavelength of light used to read the optical data storage medium, and “n” is the index of refraction of the metal oxide layer.

19. An optical data storage medium comprising: a metal layer, a metal oxide layer, a data layer, and a support substrate; wherein:
the metal layer consists of chromium metal (Cr);
the metal oxide layer consists of chromium oxide;
the data layer facially contacts the metal oxide layer;
the metal oxide layer facially contacts the metal layer;
the distance from the support substrate to the metal oxide layer is less than the distance from the support substrate to the metal layer; and
the distance from the support substrate to the data layer is less than the distance from the support substrate to the metal oxide layer.

20. A method for preparing an optical data storage medium, the method comprising:
providing at least one support substrate;
applying at least one data layer;
applying at least one metal oxide layer; and
applying at least one metal layer such that the metal oxide layer facially contacts the metal layer.

21. The method of claim 20, wherein the support substrate facially contacts the data layer.

22. The method of claim 20, wherein the data layer facially contacts the metal oxide layer.

23. The method of claim 20, further comprising applying a second support substrate.

24. The method of claim 20, wherein the metal layer comprises chromium metal (Cr), molybdenum metal (Mo), tungsten metal (W), lead metal (Pb), tantalum metal (Ta), rhodium metal (Rh), cadmium metal (Cd), indium metal (In), zinc metal (Zn), iron metal (Fe), or magnesium metal (Mg).

25. The method of claim 20, wherein the metal layer comprises chromium metal (Cr).

26. The method of claim 20, wherein the metal layer comprises molybdenum metal (Mo).

27. The method of claim 20, wherein the metal oxide layer comprises chromium oxide, molybdenum oxide, tungsten oxide, lead oxide, tantalum oxide, rhodium oxide, cadmium oxide, indium oxide, iron oxide, or magnesium oxide.

28. The method of claim 20, wherein the metal oxide layer comprises chromium oxide.

29. The method of claim 20, wherein the metal oxide layer comprises CrO, Cr₂O₃, CrO₂, Cr₅O₁₂, Cr₂O₅, CrO₃, or mixtures thereof.

30. The method of claim 20, wherein the metal oxide layer comprises molybdenum oxide.

31. The method of claim 20, wherein the metal oxide layer comprises MoO₂, MoO₃, or mixtures thereof.

32. A method of storing digital data, the method comprising:
providing an optical information medium comprising: at least one metal layer, at least one metal oxide layer, at least one data layer, and at least one support substrate; wherein the metal oxide layer facially contacts the metal layer; and
applying energy to sites in the data layer to cause a detectable change in the data layer.

33. The method of claim 32, further comprising detecting the change in the data layer.
